(19) United States
(12) Patent Application Publication
(10) Pub. No.: US 2018/0179474 A1
(43) Pub. Date: Jun. 28, 2018

(54) Polymeric Esters of Aromatic Dicarboxylic Acids as Soil Release Agents

(71) Applicants: Sasol Germany GmbH, Hamburg (DE); Henkel AG & Co. KGaA, Dusseldorf (DE)

(72) Inventors: Frank Janssen, Koln (DE); Christa Junkes, Dusseldorf (DE); Stefanie Juntermanns, Dusseldorf (DE); Sofia Mandikos, Dusseldorf (DE); Michael Dreja, Neuss (DE); Ulrike Fischer, Dorsten (DE); Udo Schoenkaes, Haltern am See (DE); Harald Kohnz, Oberhausen (DE)

(21) Appl. No.: 15/559,131

(22) PCT Filed: Mar. 8, 2016
(86) PCT No.: PCT/EP2016/054864

§ 371 Date: Jan. 15, 2018

(30) Foreign Application Priority Data
Mar. 19, 2015 (DE) 10 2015 003 483.9

(51) Int. Cl. C11D 3/37

(52) U.S. Cl. CPC C11D 3/3715

(57) ABSTRACT

The cleaning power of detergents when washing textiles was to be improved. This was accomplished mainly by using polyesters that are accessible from the dicarboxylic acid terephthalic acid and possibly isophthalic acid as well as ethylene glycol and polyethylene glycol having an average molar weights ranging from 2,000 g/mol to 8,000 g/mol.

The present invention relates to the use of certain polymeric esters of aromatic dicarboxylic acids as soil release agents for reinforcing the cleaning power of detergents when washing textiles.

In addition to ingredients such as surfactants and builder materials indispensable to the washing process, detergents generally contain other components that can be summarized under the term of detersive adjuncts and comprise very different groups of agents such as foam regulators, graying inhibitors, bleaching agents, bleach activators, and dye transfer inhibitors. Such adjuncts also include substances that lend the washing fibers soil-repellent properties and, when they are present during the washing process, support the soil-releasing ability of the other detergent components. The same also holds true accordingly for cleansers for hard surfaces. Such soil-releasing substances are frequently termed “soil release” agents or, due to their ability to make the treated surfaces such as fibers soil repellent, “soil repellents”. Accordingly for example the soil repellent effect of methylcellulose is known from American patent U.S. Pat. No. 4,136,038, and the European patent application EP 0 213 729 discloses reduced redeposition when detergents are used that contain a combination of soaps and non-ionic surfactants with alkyl hydroxyalkyl cellulose.

Due to their chemical similarity with polyester fibers in textiles made of this material, particularly effective soil repelling agents are copolyesters that contain dicarboxylic acid units such as terephthalic acid or sulfoisophthalic acid, alkylene glycol units such as ethylene glycol or propylene glycol, and polyalkylene glycol units such as polyethylene glycol. Soil-repellent copolyesters of the aforementioned type as well as their use in detergents have been known for a long time.

These polymers which are known from the prior art have the disadvantage that they are not or are insufficiently effective, especially with textiles that do not, or at least do not primarily, consist of polyester. However, a large part of today's textiles consists of cotton or cotton/polyester mixed fabrics so that there is a need for soil release agents that are also more effective on such textiles, especially with oily and fatty soiling.

It was surprisingly found that this object can be achieved by using certain esters of aromatic dicarboxylic acid.

The subject of the invention is the use of polyesters accessible from dicarboxylic acid selected from terephthalic acid and mixtures of terephthalic acid and isophthalic acid, as well as ethylene glycol and polyethylene glycol with the average molar weights (number average Mₙ) within a range of 2,000 g/mol to 8,000 g/mol, in particular 2,500 g/mol to 5,000 g/mol, wherein in the polyester, the molar ratio of terephthalic acid to isophthalic acid lies within a range of 100:0 to 40:60, in particular 100:0 to 50:50, the molar ratio of oxyethylene groups consisting of ethylene glycol and polyethylene glycol to carboxylic acid groups consisting of dicarboxylic acid lies within a range of 5:1 to 25:1, in particular 7:1 to 18:1, the molar ratio of ethylene glycol to dicarboxylic acid is less than 0.5, in particular less than 0.35, and particularly preferably lies within a range of 0.3 to 0.05, and the molar ratio of polyethylene glycol to dicarboxylic acid is greater than 0.5, and in particular greater than 0.65, and particularly preferably lies within a range of 0.7 to 1, and the average molar weight (number average Mₙ) of polyethylene glycol is below 1,000 g/mol, in particular lies within a range of 300 g/mol to 800 g/mol, to reinforce the cleaning power of detergents when washing textiles, in particular against oily and fatty soiling.

The substances used according to the invention are polymer esters consisting of terephthalic acid, ethylene glycol and polyethylene glycol, wherein the terephthalic acid can be partially replaced by isophthalic acid. These are accessible from the aforementioned compounds by esterification methods which are known in principle, wherein instead of the aforementioned dicarboxylic acids, their reactive derivatives such as anhydrides, acid chlorides or low alkyl esters such as methyl or ethyl esters can be used. It can contain the units originating from the aforementioned compounds in a statistical distribution, or be a so-called block copolyester that for example contains terephthalic acid ethylene glycol blocks, terephthalic acid polyethylene glycol blocks, isophthalic acid ethylene glycol blocks and/or isophthalic acid polyethylene glycol blocks onto which the compounds not contained within the block component are condensed, wherein the statistical distribution is preferred. The polymer does not contain any other units than those that originate from the aforementioned compounds; on the ends, it has OH groups originating from ethylene glycol or polyethylene glycol.

Another subject of the invention is a method for washing textiles in which a detergent and a soil release agent are used in the form of one of the above-defined polyesters. Within the context of this method, soiled textiles are brought into contact with water and the aforementioned substances in order to remove the soiling from the textiles entirely or at least to a satisfactory extent. These methods can be performed manually or possibly with the assistance of a conventional household washing machine. In so doing, it is possible to use the detergent and soil release agent simultaneously or sequentially. Simultaneous use can be performed particularly advantageously by using a detergent that contains the soil release agent.

The effect of the agent to be used according to the invention is particularly pronounced in multiple use, i.e., in particular to remove soiling from textiles that have already been washed and/or aftertreated in the presence of the agent before they were provided with the soiling to be removed. With regard to the aftertreatment, it should be noted that the identified positive aspect can also be realized in a washing method in which the textile is brought into contact with an aftertreatment means such as in the context of a softening step that contains an agent to be used according to the invention after the actual washing procedure that is carried out with the assistance of a detergent which can contain an aforementioned agent, but which can also be free thereof in this case. In this approach as well, the washing-performance-enhancing effect of the agents to be used according to the invention is also apparent in the next washing procedure, even when a detergent is again used as desired without an agent to be used according to the invention. This is significantly greater than an effect that results when a conventional soil release agent is used. In a particularly preferred embodiment, the agent essential to the invention is added in the softening cycle of textile laundry.

The agent used according to the invention causes a significantly improved release of especially fat or cosmetic soiling of textiles made of polyester as well as textiles made of cotton, or respectively cotton containing-material, than is the case when compounds that were previously known for this purpose are used. Alternatively, surfactants can be spared while the fat-releasing performance remains the same.

The use according to the invention can be realized in the context of a washing process in that the soil release agent is added to a detergent-containing washing liquor, or preferably the agent is added as a component of a detergent to the liquor which contains the object to be cleaned, or is brought into contact therewith.

The use according to the invention in the context of a laundry aftertreatment method can correspondingly be realized in that the soil release agent is added separately to the rinsing liquor which is used after a washing cycle using a detergent that in particular contains bleach, or the agent is introduced as a component of the laundry aftertreatment means, in particular a fabric softener. In this aspect of the invention, the detergent which is used before the laundry aftertreatment means can also contain an agent to be used according to the invention, but it can also be free thereof, however.

Other subjects of the present invention are detergent or laundry aftertreatment means that contain a cited polyester. These are preferably water-containing and liquid and have in particular a water content ranging from 50% by weight to 90% by weight.

The washing process is preferably carried out at a temperature of 15° C. to 60° C., particularly preferably at a temperature of 20° C. to 40° C. The washing process is moreover preferably carried out at a pH of 6 to 11, particularly preferably at a pH of 7.5 to 9.5. The used concentration of the above-defined carboxylic acid ester in the washing or laundry aftertreatment liquor preferably lies within a range of 0.0001 WI to 10 g/l, in particular from 0.005 g/l to 1 g/l.

Means that contain an agent to be used according to the invention or are used together therewith, or respectively are used in a method according to the invention, can contain all of the conventional additional components of such means that do not interact in a undesirable manner with the agent essential to the invention, in particular a surfactant. Preferably, the above-defined agent is used in amounts of 0.001% by weight to 10%, in particular from 0.01% by weight to 5% by weight, and particularly preferably from 0.3% by weight to 1.5% by weight, wherein these and the following figures refer to the overall means if not otherwise indicated.

A means that contains an agent to be used according to the invention, or is used therewith, or is used in a method according to the invention, contains peroxygen-based bleach, in particular when it is in solid form, in particular in amounts ranging from 5% by weight to 70% by weight, and possibly bleach activator, in particular in amounts ranging from 0.3% by weight to 10% by weight, and can, however, also be free of bleach and bleach activator in another preferred embodiment, in particular when it is in liquid form. The possible bleaches are preferably the peroxygen compounds which are generally used in detergents like percarboxylic acids, such as dodecane diperacid or phthaloylaminoperoxicaproic acid, hydrogen peroxide, alkali perborate which can be present as tetra- or monohydrate, percarbonate, perpyrophosphate and persilicate that is generally present as alkali salts, in particular as sodium salts. Such bleaches are present in detergents that contain an agent to be used according to the invention, preferably in amounts up to 25% by weight, in particular up to 15% by weight, and particularly preferably from 5% by weight to 15% by weight, with reference in each case to the overall means, wherein in particular percarbonate is used. The optional component of the bleach activators comprises the normally used N- or O-acyl compounds such as multiple acylated alkylene diamine, in particular tetraacetylethylene diamine, acylated glycolurils, in particular tetraacetylglycoluril, N-acylated hydantoins, hydrazides, triazoles, urazoles, diketopiperazines, sulfurylamides and cyanurates, as well as carboxylic acid anhydrides, in particular phthalic acid anhydride, carboxylic acid esters, in particular sodium nonanoyl and isononanoylphenol sulfonate, and acylated sugar derivatives, in particular pentaacetyl glucose, as well as cationic nitrile derivatives such as trimethylammonium acetonitrile salts. The bleach activators can be coated in a known manner with coating substances or for example be granulated to avoid interaction with the peracid compounds during storage, wherein with the assistance of carboxymethylcellulose, granulated tetraacetylethylene diamine with average weight particle sizes of 0.01 mm to 0.8 mm, granulated 1,6-diacetyl-2,4-dioxohexahydro-1,3,5-triazine, and/or trialkylammonium acetonitrile prefabricated in particle form is particularly preferred. In detergents, such bleach activators are preferably incorporated in amounts up to 8% by weight, in particular from 2% by weight to 6% by weight, in each case with reference to the overall means.

In a preferred embodiment, a means used according to the invention, or in the method according to the invention, contains non-ionic surfactant selected from fatty alkyl polyglycosides, fatty alkyl polyalkoxylates, in particular ethoxylates and/or propoxylates, fatty acid polyhydroxyamides and/or ethoxylation and/or propoxylation products of fatty alkylamines, vicinal dioles, fatty acid alkyl esters, as well as their mixtures, in particular in an amount ranging from 2% by weight to 25% by weight.

Another embodiment of such means comprises the presence of synthetic anionic surfactants of the sulfate and/or sulfonate type, in particular fatty alkyl sulfate, fatty alkyl ether sulfate, sulfofatty acid esters and/or sulfofatty acid disalts, in particular in an amount ranging from 2% by weight to 25% by weight. Preferably, the anionic surfactant is selected from alkyl or alkenyl sulfates, and/or alkyl or alkenyl ether sulfates in which the alkyl or alkenyl group possesses 8 to 22, in particular 12 to 18 C atoms. These are normally not individual substances but rather cuts or mixtures. Among these, those are preferred with a percentage of compounds with more than 20% by weight long chain groups ranging from 16 to 18 C atoms.

The possible non-ionic surfactants include alkoxylates, in particular ethoxylates and/or propoxylates of saturated or monounsaturated to polyunsaturated linear or branched chain alcohols with 10 to 22 C atoms, preferably 12 to 18 C atoms. The degree of alkoxylation of the alcohols is generally between 1 and 20, preferably between 3 and 10. They can be produced in a known manner by reacting the corresponding alcohols with the corresponding alkylene oxides. Particularly suitable are the derivatives of fatty alcohols, although their branched-chain isomers, in particular so-called oxoalcohols, can also be used to produce useful alkoxylates. Alkoxylates, in particular ethoxylates, primary alcohols with linear groups, in particular dodecyl, tetradecyl, hexadecyl or octadecyl and their mixtures are accordingly useful. Moreover, corresponding alkoxylation products of alkyl amines, vicinal diols and carboxylic acid amides that correspond to the aforementioned alcohols in terms of their alkyl portion are useful. In addition, the ethylene oxide and/or propylene oxide insertion products of fatty acid alkyl esters and fatty acid polyhydroxyamides are possible. So-called alkylpolyglycosides suitable for incorporation in the means are compounds with general formula (G)ₙ-OR¹², in which R¹² means an alkyl or alkenyl group with 8 to 22 C atoms, G is a glycose unit, and n is a number between 1 and 10. The glycoside component (G)ₙ is an oligomer or polymer from naturally occurring aldose or ketose monomers, to which belong in particular glucose, mannose, fructose, galactose, talose, gulose, altrose, allose, idose, ribose, arabinose, xylose and lyxose. The oligomers consisting of such glycosidically linked monomers are characterized by their number, the so-called degree of oligomerization, in addition to the type of sugar that they contain. The average degree of oligomerization n is generally a fraction as an analytically determined quantity; it lies between values of 1 and 10, and below a value of 1.5, especially ranging from 1.2 to 1.4, with the glycosides that are preferably used. The preferred monomer component is glucose given the favorable availability. The amount of alkyl or alkenyl R¹² in the glycoside preferably also originates from easily-accessible derivatives of renewable raw materials, in particular fatty alcohols, although their branched-chain isomers, in particular so-called oxoalcohols, can also be used to produce useful glycosides. Accordingly, in particular the primary alcohols with linear octyl, decyl, dodecyl, tetradecyl, hexadecyl or octadecyl groups, as well as their mixtures, are useful. Particularly preferred alkyl glycosides contain a coconut fatty alkyl group, i.e., mixtures where basically R¹²=dodecyl and R¹²=tetradecyl.

Non-ionic surfactant is used according to the invention in means that contain a soil release agent used according to the invention, or in means that are used in the method according to the invention, and are preferably contained in amounts of 1% by weight to 30% by weight, in particular from 1% by weight to 25% by weight, wherein amounts in the upper portion of this range tend to be found in liquid detergents, and particulate detergents preferably tend to contain smaller amounts up to 5% by weight.

The means can instead or in addition contain other surfactants, preferably synthetic anionic surfactants of the sulfate or sulfonate type, such as alkyl benzene sulfonates, in amounts preferably not exceeding 20% by weight, in particular in amounts of 0.1% to 18% by weight, with reference in each case to the overall means. Synthetic anionic surfactants that are particularly suitable for use in such means are alkyl and/or alkenyl sulfates with 8 to 22 C atoms that bear an alkali, ammonium or alkyl or hydroxyalkyl-substituted ammonium ion as a countercation. The derivatives of fatty alcohols are preferable with in particular 12 to 18 C atoms and their branched-chain analogs, the so-called oxoalcohols. The alkyl and alkenyl sulfates can be produced in a known manner by reacting the corresponding alcohol component with a routine sulfatization reagent, in particular sulfur trioxide or chlorosulfonic acid, followed by neutralization with alkali-, ammonium- or alkyl-, or respectively, hydroxyalkyl-substituted ammonium bases. Useful surfactants of the sulfate type also include the sulfated alkoxylation products of the aforementioned alcohols, so-called ether sulfates. Preferably, such ether sulfates contain 2 to 30, in particular 4 to 10 ethylene glycol groups per molecule. Suitable anionic surfactants of the sulfonate type include the α-sulfoesters, obtainable by reacting fatty acid esters with sulfur trioxide followed by neutralization, in particular the sulfonization products deriving from fatty acids with 8 to 22 C atoms, preferably 12 to 18 C atoms, and linear alcohols with 1 to 6 C atoms, preferably 1 to 4 C atoms, as well as the sulfofatty acids resulting therefrom by formal saponification.

Soaps are possible as other optional surfactant contents, wherein saturated fatty acid soaps are suitable such as the salts of lauric acid, myristic acid, palmitic acid or stearic acid, as well as soaps consisting of natural fatty acid mixtures such as coconut, palm kernel or tallow fatty acids. In particular, such soap mixtures are preferred that are composed of 50% by weight to 100% by weight of saturated C₁₂-C₁₈ fatty acid soaps, and up to 50% by weight of oleic acid soap. Preferably, the amount of contained soap is 0.1% by weight to 5% by weight. However, higher amounts of soap of generally up to 20% by weight can be contained in particular in liquid means that contain a polymer used according to the invention.

If desired, the means can also contain betaines and/or cationic surfactants which, if available, are preferably used in amounts of 0.5% by weight to 7% by weight. Among these, the esterquats discussed below are particularly preferred.

In another embodiment, the means contain water-soluble and/or water-insoluble builders, in particular selected from alkali aluminosilicate, crystalline alkali silicate with a modulus greater than 1, monomer polycarboxylate, polymer polycarboxylate and mixtures thereof, in particular in amounts ranging from 2.5% by weight to 60% by weight.

The means preferably contain 20% by weight to 55% by weight water-soluble and/or water insoluble organic and/or inorganic builders. The water-soluble organic builder substances include in particular those from the class of polycarboxylic acids, in particular citric acid and sugar acids, as well as the polymer (poly)carboxylic acids, in particular the polycarboxylates accessible by oxidizing polysaccharides, polymer acrylic acids, methacrylic acids, maleic acids and mixed polymers thereof that can also contain slight amounts of polymerizable substances without a carboxylic acid function incorporated by polymerization. The relative molecular mass of the homopolymers of unsaturated carboxylic acids is generally between 5,000 g/mol and 200,000 g/mol, and that of the copolymers is between 2,000 g/mol and 200,000 g/mol, preferably 50,000 g/mol to 120,000 g/mol, with reference to the free acid. A particularly preferred acrylic acid/maleic acid copolymer has a relative molecular mass of 50,000 g/mol to 100,000 g/mol. Suitable although less preferred compounds of this class are copolymers of acrylic acid or methacrylic acid with vinyl ethers such as vinyl methyl ethers, vinyl esters, ethylene, propylene and styrene in which the amount of acid is at least 50% by weight. Terpolymers can also be used as the water soluble organic builder substances that contain two carboxylic acids and/or their salts as monomers, as well as a third monomer vinyl alcohol and/or a vinyl alcohol derivative, or a carbohydrate. The first acid monomer, or respectively its salt, is derived from a monoethylenically unsaturated C₃-C₈ carboxylic acid and preferably a C₃-C₄ monocarboxylic acid, in particular (meth)acrylic acid. The second acid monomer, or respectively its salt, can be a derivative of a C₄-C₈ dicarboxylic acid, wherein maleic acid is particularly preferred. The third monomer unit in this case is formed by vinyl alcohol and/or preferably an esterified vinyl alcohol. In particular, vinyl alcohol derivatives are preferred that constitute an ester of short-chain carboxylic acids, preferably C₁-C₄ carboxylic acids with vinyl alcohol. Preferred terpolymers contain 60% by weight to 95% by weight, and in particular 70% by weight to 90% by weight (meth)acrylic acid and/or (meth)acrylate, particularly preferably acrylic acid and/or acrylate and maleic acid and/or maleinate, as well as 5% by weight to 40% by weight, preferably 10% by weight to 30% by weight, vinyl alcohol and/or vinyl acetate. Particularly preferred are terpolymers in which the weight ratio of (meth)acrylic acid and/or (meth)acrylate to maleic acid and/or maleate lies between 1.1 and 4.1, preferably between 2:1 and 3:1, and especially 2:1 in 2.5:1. Both the amounts and weight ratios refer to the acids. The second acid monomer, or respectively its salt, can also be a derivative of an allyl sulfonic acid that is substituted at the 2-position by an alkyl group, preferably a C₁-C₄ alkyl group, or an aromatic group which is preferably derived from benzene or benzene derivatives. Preferred terpolymers contain 40% by weight to 60% by weight, in particular 45 to 55% by weight (meth)acrylic acid and/or (meth)acrylate, particularly preferably acrylic acid and/or acrylate, 10% by weight to 30% by weight, preferably 15% by weight to 25% by weight methallyl sulfonic acid and/or methallyl sulfonate and, as a third monomer, 15% by weight to 40% by weight, preferably 20% by weight to 40% by weight carbohydrate. This carbohydrate can for example be a mono, di, oligo or polysaccharide, wherein mono, di, or oligosaccharides are preferred, and saccharose is particularly preferred. By using the third monomer, predetermined breaking points are assumedly incorporated in the polymer that are responsible for the favorable biodegradation of the polymer. The terpolymers generally have a relative molecular mass between 1,000 g/mol and 200,000 g/mol, preferably between 3,000 g/mol and 10,000 g/mol. In particular to produce liquid means, they can be used in the form of aqueous solutions, preferably in the form of 30% to 50% by weight aqueous solutions. All of the aforementioned polycarboxylic acids are generally used in the form of their water-soluble salts, in particular their alkali salts.

Such organic builder substances are preferably contained in amounts up to 40% per weight, in particular up to 25% by weight, and particularly preferably 1% by weight to 5% by weight. Amounts close to the aforementioned upper limit are preferably used in pasty or liquid, in particular water-containing means.

In particular, crystalline or amorphous alkali aluminosilicates are preferably used as water-insoluble, water-dispersible inorganic builder materials, in amounts up to 50% by weight, preferably not more than 40% by weight, and in particular 1% by weight to 5% by weight in liquid means. Of these, the crystalline, detergent-quality aluminosilicates are preferred, in particular the zeolite NaA and possibly NaX. Amounts close to the aforementioned upper limit are preferably used in solid or particulate means. Suitable aluminosilicates in particular do not have any particles with a particle size above 30 μm, and preferably consist of at least 80% by weight of particles with a size below 10 μm. Their calcium binding ability that can be determined according to German patent DE 24 12 837 lies within the range of 100 to 200 mg CaO per gram. Suitable substitutes, or respectively partial substitutes for the aforementioned aluminosilicates are crystalline alkali silicates that can be present by themselves or in a mixture with amorphous silicates. The alkali silicates which can be used as structural materials in the means preferably have a molar ratio of alkali oxide to SiO₂ below 0.95, in particular from 1:1.1 to 1:12, and can be amorphous or crystalline. Preferred alkaline silicates are sodium silicates, in particular amorphous sodium silicates with a molar ratio of Na₂O:SiO₂ from 1:2 to 1:2.8. Such amorphous alkali silicates are commercially available for example under the name of Portil®. In the context of production, they are preferably added as a solid and not in the form of a solution. Preferably crystalline layer silicates of the general formula Na₂SiₓO₂ₓ₊₁.yH₂O are used as the crystalline silicates which can be present by themselves or in mixture with amorphous silicates and in which x, the so-called modulus, is a number from 1.9 to 4, and y is a number from 0 to 20, and preferable values for x are 2, 3 or 4. Preferred crystalline layer silicates are those in which x in the aforementioned general formula assumes the value 2 or 3. In particular, both β- as well as δ-sodium silicates (Na₂Si₂O₅.yH₂O) are preferred. Practically water free crystalline alkali silicates of the aforementioned general formula also produced from amorphous alkali silicates in which x is a number from 1.9 to 2.1, can also be used in means that contain an agent to be used according to the invention. In another preferred embodiment of means according to the invention, a crystalline sodium layer silicate with a modulus of 2 to 3 is used as can be produced from sand and soda. Crystalline sodium silicates with a modulus ranging from 1.9 to 3.5 are used in another preferred embodiment of detergents that contain an agent used according to the invention. The amount of alkali silicates is preferably 1% by weight to 50% by weight, and in particular 5% by weight to 35% by weight with reference to the water-free active substance. If aluminosilicate, in particular zeolite, is also present as an additional builder substance, the amount of alkali silicate is preferably 1% by weight to 15% by weight, and in particular 2% by weight to 8% by weight with reference to the water-free active substance. The weight ratio of aluminosilicate to silicate, with reference to the water-free active substance, is then preferably 4:1 to 10:1. In means that contain both amorphous and crystalline alkali silicates, the weight ratio of amorphous alkali silicate to crystalline alkali silicate is preferably 1:2 to 2:1 and in particular 1:1 to 2:1.

In addition to the aforementioned inorganic builders, other water-soluble or water-insoluble inorganic substances can be contained in the means that contain an agent to be used according to the invention and used together with this agent, or respectively in the method according to the invention. In this context, the alkali carbonates, alkali hydrogen carbonates, and alkali sulfates as well as their mixtures are suitable. Such additional inorganic material can be present in amounts up to 70% by weight.

In addition, the means can contain other components which are conventional in detergents and cleansers. These optional components include in particular enzymes, enzyme stabilizers, complexing agents for heavy metals such as amino polycarboxylic acids, amino hydroxypolycarboxylic acids, polyphosphonic acids and/or amino polyphosphonic acids, foam inhibitors such as organopolysiloxanes or paraffins, solvents and optical brightners such as stilbene disulfonic acid derivatives. Preferably means that contain an agent used according to the invention contain up to 1% by weight, in particular 0.01% by weight to 0.5% by weight optical brighteners, in particular compounds from the class of substituted 4,4′-bis-(2,4,6-triamino-s-triazinyl)-stilbene-2,2′-disulfonic acids, up to 5% by weight, in particular 0.1% by weight to 2% by weight complexing agents for heavy metals, in particular amino alkylene phosphonic acids and their salts, and up to 2% by weight, in particular 0.1% by weight to 1% by weight foam inhibitors.

In addition to water, solvents that can be used in particular in liquid means, are preferably those that are water-miscible. These include the low alcohols such as ethanol, propanol, isopropanol, and isomer butanols, glycerin, low glycols such as ethylene and propylene glycol, and ethers derivable from the aforementioned classes of compounds. The agents used according to the invention are generally present dissolved or in suspended form in such liquid.

Enzymes that may be present are preferably selected from the group comprising protease, amylase, lipase, cellulase, hemicellulase, oxidase, peroxidase or mixtures thereof. Mainly proteases obtained from microorganisms such as bacteria or fungi are worth considering. They can be obtained in a known manner by fermentation processes from suitable microorganisms. Proteases are commercially available for example under the names of BLANP®, Savinase®, Esperase®, Maxatase®, Optimase®, Alcalase®, Durazym® or Maxapem®. The useful lipase can for example be obtained from Humicola lanuginosa, Bacillus strains, Pseudomonas strains, Fusarium strains, Rhizopus strains, or from Aspergillus strains. Suitable lipases are for example commercially available under the names of Lipolase®, Lipozym®, Lipomax®, Lipex®, Amano® lipase, Toyo-Jozo® lipase, Meito® lipase and Diosynth® lipase. Suitable amylases are for example commercially available under the names of Maxamyl®, Termamyl®, Duramyl® and Purafect® OxAm. The useful cellulase can be an enzyme obtainable from bacteria or fungi that has an optimum pH preferably in the slightly acidic to slightly alkaline range of 6 to 9.5. Such cellulases are commercially available under the names of Celluzyme®, Carezyme® and Ecostone®.

The conventional enzyme stabilizers that may be present in particular in liquid means include amino alcohols such as mono, di, and triethanol amine and mono, di, and tripropanol amine and their mixtures, low carboxylic acids, boric acid, or respectively alkali borates, boric acid/carboxylic acid combinations, boric acid esters, boric acid derivatives, calcium salts such as calcium/formic acid combination, magnesium salts, and/or sulfur-containing reduction agents.

Suitable foam inhibitors include long-chain soaps, in particular behenic soap, fatty acid amides, paraffins, waxes, microcrystalline waxes, organopolysiloxanes and their mixtures which may also contain microfine, possibly silanized or otherwise waterproofed silicic acid. For use in particulate means, such foam inhibitors are preferably bound to granular water-soluble carrier substances.

In a preferred embodiment, a means in which agent to be used according to the invention is incorporated is particulate, and contains up to 25% by weight, in particular 5% by weight to 20% by weight bleach, in particular alkali percarbonate, up to 15% by weight, in particular 1% by weight to 10% by weight bleach activator, 20% by weight to 55% by weight inorganic builder, up to 10% by weight, in particular 2% by weight to 8% by weight water soluble organic builder, 10% by weight to 25% by weight synthetic anionic surfactant, 1% by weight to 5% by weight non-ionic surfactant, and up to 25% by weight, in particular 0.1% by weight to 25% by weight inorganic salts, in particular alkali carbonate and/or alkali hydrogen carbonate.

In another preferred embodiment, a means in which the agent to be used according to the invention is incorporated is liquid, and contains 1% by weight to 25% by weight, in particular 5% by weight to 15% by weight non-ionic surfactant, up to 10% by weight, in particular 0.5% by weight to 8% by weight synthetic anionic surfactant, 3% by weight to 15% by weight, in particular 5% by weight to 10% by weight soap, 0.5% by weight to 5% by weight, in particular 1% by weight to 4% by weight organic builder, in particular polycarboxylate such as citrate, up to 1.5% by weight, in particular the 0.1% by weight of to 1% by weight complexing agent for heavy metals such as phosphonate, and in addition to any contained enzyme, enzyme stabilizer, dye and/or fragrance and water, and/or water-miscible solvent.

It is also possible to use a combination of a soil release agent essential to the invention with another soil release polymer consisting of a dicarboxylic acid and a possibly polymer diol to enhance the cleaning power of detergents when washing textiles. Also in the context of the means used according to the invention and the method according to the invention, such combinations are possible with such a different, in particular polyester-active soil release polymer.

The known polyester-active soil release polymers that can be used in addition to the agents essential to the invention include copolyesters consisting of dicarboxylic acids such as an adipic acid, phthalic acid or terephthalic acid, diols such as ethylene glycol or propylene glycol and polydiols such as polyethylene glycol or polypropylene glycol. The preferably used soil-release polyesters include such compounds that are formally accessible by the esterification of two monomer parts, wherein the first monomer is a dicarboxylic acid HOOC-Ph-COOH, and the second monomer is a diol HO—(CHR¹¹—)ₐOH that can also be present as a polymer diol H—(O—(CHR¹¹—)ₐ)_{b}OH. In this context, Ph means a o-, m- or p-phenylene group that can bear 1 to 4 substituents selected from alkyl groups with 1 to 22 C atoms, sulphonic acid groups, carboxyl groups and their mixtures, R¹¹ means hydrogen, an alkyl group with 1 to 22 C atoms and their mixtures, and “a” means a number from 2 to 6, and “b” means a number from 1 to 300. Preferably both monomer diol units —O—(CHR¹¹—)ₐO— as well as polymer diol units —(O—(CHR¹¹—)ₐ)_{b}O— are present in the polyesters obtainable therefrom. The molar ratio of monomer diol units to polymer diol units is preferably 100:1 to 1:100, in particular 10:1 to 1:10. The degree of polymerization b preferably lies within the range of 4 to 200, in particular 12 to 140 in the polymer diol units. The molar weight, or respectively the average molar weight, or the maximum molar weight distribution of preferred soil release polyesters lies within a range of 250 g/mol to 100,000 g/mol, in particular from 500 g/mol to 50,000 g/mol. The acid on which the group Ph is based is preferably selected from terephthalic acid, isophthalic acid, phthalic acid, trimellitic acid, mellitic acid, the isomers of sulfophthalic acid, sulfoisophthalic acid and sulfoterephthalic acid, as well as their mixtures. If their acid groups are not part of the ester bonds in the polymer, they are preferably in the form of salt, in particular as an alkali or ammonium salt. Among these, the sodium and potassium salts are particularly preferred. In particular slight amounts, in particular not more than 10% by mol with reference to the amount of Ph with the above meaning, of other acids that have at least two carboxyl groups can be contained in the soil-release polyester instead of the monomer HOOC-Ph-COOH. These include for example alkylene and alkenylene dicarboxylic acids such as malonic acid, succinic acid, fumaric acid, maleic acid, glutaric acid, adipic acid, pimelic acid, suberic acid, azelaic acid and sebacic acid. The preferred diols HO—(CHR¹¹—)ₐOH include those in which R¹¹ is hydrogen and “a” is a number from 2 to 6, and those in which “a” has the value 2, and R¹¹ is selected from hydrogen and the alkyl groups with 1 to 10, in particular 1 to 3 C atoms. Among the last cited diols, those of formula HO—CH₂—CHR¹¹—OH, in which R¹¹ possesses the aforementioned meaning are particularly preferred. Examples of diol components are ethylene glycol, 1,2-propylene glycol, 1,3-propylene glycol, 1,4-butane diol, 1,5-pentane diol, 1,6-hexane diol, 1,8-octane diol, 1,2-decane diol, 1,2-dodecane diol and neopentyl glycol. Particularly preferable among the polymer diols is polyethylene glycol with an average molar mass ranging from 1,000 g/mol to 6,000 g/mol.

If desired, these polyesters as well as those composed as described above can also be end-capped, wherein alkyl groups with 1 to 22 C atoms and esters of monocarboxylic acids are possible end groups. The end groups bound by ester bonds can be based on alkyl, alkenyl and aryl monocarboxylic acids with 5 to 32 C atoms, in particular 5 to 18 C atoms. These include valeric acid, caproic acid, oenanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidinic acid, oleic acid, linolenic acid, linolaidinic acid, linolenic acid, eleostearic acid, arachinic acid, gadoleic acid, arachidonic acid, behenic acid, erucic acid, brassidinic acid, clupanodonic acid, lignoceric acid, cerotinic acid, melissinic acid, benzoic acid that can bear 1 to 5 substituents with a total of up to 25 C atoms, in particular 1 to 12 C atoms, such as tert.-butylbenzoic acid. The end group can also be based on hydroxymonocarboxylic acids with 5 to 22 C atoms that for example include hydroxyvaleric acid, hydroxycaproic acid, ricinoleic acid, its hydration product hydroxystearic acid, and o-, m- and p-hydroxybenzoic acid. For their part, the hydroxymonocarboxylic acids can be bound to each other by their hydroxyl group and their carboxyl group, and can accordingly occurs several times in an end group. Preferably, the number of hydroxymonocarboxylic acid units per end group, i.e., their degree of oligomerization, can range from 1 to 50, in particular from 1 to 10. In a preferred embodiment of the invention, polymers consisting of ethylene terephthalate and polyethylene oxide terephthalate, in which the polyethylene glycol units have molar weights of 750 to 5,000 g/mol, and the molar ratio of ethylene terephthalate to polyethylene oxide terephthalate is 50:50 to 90:10, are used in combination with an agent according to the invention.

The polyester-active soil-release polymers which may also be used are preferably water-soluble like the polyesters used according to the invention, wherein the term “water-soluble” is to be understood as a solubility of at least 0.01 g, preferably at least 0.1 g of the polymer per liter water at room temperature with a pH of 8. However, polymers which are preferably used have a solubility of at least 1 g per liter under these conditions, in particular at least 10 g per liter.

Preferred laundry aftertreatment means that contain an agent to be used according to the invention have a so-called esterquat as the laundry-softening agent, i.e., a quaternated ester consisting of carboxylic acid and amino alcohol. These are known substances that can be obtained by the relevant methods of preparative organic chemistry, for example by partially esterifying triethanol amine in the presence of hypophosphorous acid with fatty acids, running air through, and then quaternating with dimethyl sulfate or ethylene oxide. The production of solid esterquats is also known in which the quaternation of triethanol amine esters is performed in the presence of suitable dispersants, preferably fatty alcohols.

Preferred esterquats in the means are quaternated fatty acid triethanol amine ester salts that follow formula (IV),

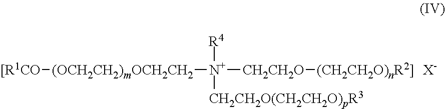

in which R¹CO stands for an acyl group with 6 to 22 carbon atoms, R² and R³ independently stand for hydrogen or R¹CO, R⁴ stands for an alkyl group with 1 to 4 carbon atoms or a (CH₂CH₂O)_{q}H group, m, n and p together stand for 0 or numbers from 1 to 12, q stands for numbers from 1 to 12, and X stands for a charge-balancing anion such as halogenide, alkyl sulfate or alkyl phosphate.

Typical examples of esterquats that can be used according to the invention are products based on caproic acid, caprylic acid, capric acid, lauric acid, myristic acid, palmitic acid, isostearic acid, stearic acid, oleic acid, elaidic acid, arachidic acid, behenic acid and erucic acid as well as their technical mixtures as they for sample occur in the splitting of natural fats and oils under pressure. Preferably, technical C_{12/18}-coconut fatty acids and in particular partially hardened C_{16/18}-tallow, or respectively palm fatty acids and elaidic-acid-rich C_{16/18}-fatty acid cuts are used. To produce the quaternated esters, the fatty acids and the triethanol amine can generally be used in a molar ratio of 1.1:1 to 3:1. With regard to the practical properties of the esterquats, a used ratio of 1.2:1 to 2.2:1, preferably 1.5:1 to 1.9:1 has proven to be particularly advantageous. The preferably used esterquats are technical mixtures of mono-, di- and triesters with an average esterification of 1.5 to 1.9, and can be derived from technical C_{16/18}-tallow, or respectively palm fatty acid (iodine number 0 to 40). Quaternated fatty acid triethanol amine ester salts of formula (IV), in which R¹CO stands for an acyl group with 16 to 18 carbon atoms, R² stands for R¹CO, R³ stands for hydrogen, R⁴ stands for a methyl group, m, n and p stand for 0, and X stands for methyl sulfate, have proven to be particularly advantageous.

In addition to quaternated carboxylic acid triethanol amine ester salts, quaternated ester salts of carboxylic acids with diethanol alkyl amines of formula (V) are possible as esterquats,

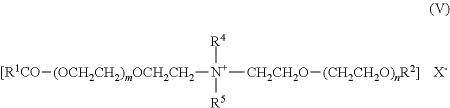

in which R¹CO stands for an acyl group with 6 to 22 carbon atoms, R² stands for hydrogen or R¹CO, R⁴ and R⁵ independently stand for alkyl groups with 1 to 4 carbon atoms, m and n together stand for 0 or numbers from 1 to 12, and X stands for a charge-balancing anion such as halogenide, alkyl sulfate or alkyl phosphate.

In conclusion, the quaternated ester salts of carboxylic acids with 1,2-dihydroxypropyl dialkyl amines of formula (VI) are mentioned as other groups of suitable esterquats,

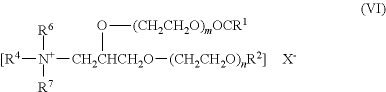

in which R¹CO stands for an acyl group with 6 to 22 carbon atoms, R² stands for hydrogen or R¹CO, R⁴, R⁶ and R⁷ independently stand for alkyl groups with 1 to 4 carbon atoms, m and n together stand for 0 or numbers from 1 to 12, and X stands for a charge-balancing anion such as halogenide, alkyl sulfate or alkyl phosphate.

With regard to the selection of the preferred fatty acids and the optimum degree of esterification, the data cited with regard to (IV) as an example accordingly applies to the esterquats of formulas (V) and (VI). Normally, the esterquats are marketed in the form of 50 to 90% by weight alcoholic solutions which can also be easily diluted with water, wherein ethanol, propanol and isopropanol are the normal alcoholic solutions.

Esterquats are preferably used in amounts of 5% by weight to 25% by weight, in particular 8% by weight to 20% by weight, with reference to the overall laundry after-treatment means. If desired, the laundry after-treatment means used according to the invention can also contain the aforementioned detergent contents, providing that they do not negatively interact with the esterquat in an unacceptable manner. Preferably, the means are liquid and contain water.

### EXAMPLES

### Example 1: Production of Polyesters Used in Washing Tests

286 g terephthalic acid, 157.8 g isophthalic acid, 794 g polyethylene glycol PEG 400, 199.2 g ethylene glycol and 1.4 g phosphorus acid were heated to 120° C. in a multi-neck flask with an agitator, inner thermometer, inert gas feed and distillation head, heated over 4 hours from 120° C. to 230° C., and maintained at this temperature. The water arising during esterification was distilled off at ambient pressure. Once no more distillate arose, the pressure was reduced in steps to 10 mbar. Under these conditions, water (95.9 g) as well as ethylene glycol (127.1 g) arose as distillate. Esterification continued until the acid number of the reaction mixture was below 1 mg KOH/g, and the hydroxyl number was approximately 35 mg KOH/g.

### Example 2: Production of Polyesters Used in Washing Tests

296 g terephthalic acid, 1070 g polyethylene glycol PEG 600, 133 g ethylene glycol and 1.4 g phosphorous acid were esterified as described in example 1 (apparatus and conditions) until the acid number of the reaction mixture was below 1 mg KOH/g and the hydroxyl number was approximately 40 mg KOH/g. 63.7 g water, and 92.5 g ethylene glycol arose as distillate.

### Example 3: Washing Tests

Washing machine: Miele W 918 Novotronic®

### Temperature: 40° C.

Washing volume: 17 l
Water hardness: 16° dH (German hardness)
Ballast laundry: Clean laundry (pillow, jersey, washcloth); 3.5 kg minus the weight of the textiles

The cotton and polyester test textiles were washed three times in the presence of the ballast laundry with a detergent liquor according to the above information that contained 66 ml of detergent V1, or one of detergents E1, E2, E3 or E4 (the composition is indicated in Table 1) with the polyester produced in example 1. The laundry was air-dried after washing.

TABLE 1
Detergent compositions [% by weight]:

| | V1 | E1 | E2 | E3 | E4 |
|---|---|---|---|---|---|
| C12-14-fatty alcohol with 7 EO | 7 | 7 | 7 | 7 | 7 |
| C12-18-fatty acid, sodium salt | 10 | 10 | 10 | 10 | 10 |
| Boric acid | 4 | 4 | 4 | 4 | 4 |
| Citric acid | 2 | 2 | 2 | 2 | 2 |
| Propane diol | 6 | 6 | 6 | 6 | 6 |
| NaOH | 3 | 3 | 3 | 3 | 3 |
| Protease | 0.6 | 0.6 | 0.6 | 0.6 | 0.6 |
| Amylase | 0.1 | 0.1 | 0.1 | 0.1 | 0.1 |
| Polymer from example 1 | — | 0.3 | 0.6 | 1.0 | 1.5 |

| | |
|---|---|
| Water | up to 100 |

Standard soiling was then applied to the test textiles which were then stored for 7 days at room temperature. The test textiles were then re-washed together with the ballast laundry in a wash liquor containing 66 ml of the previously-used detergent composition under the described conditions. The remaining spot intensity was determined with a DATA-COLOR Spectra Flash SF500 remission spectrometer. Table 2 shows the differences of the spot intensities when using means E1 to E4 according to the invention in comparison to the use of means V1.

TABLE 2
Differences in spot intensity

| Soiling/means | E1 | E2 | E3 | E4 |
|---|---|---|---|---|
| Lipstick 1 on cotton | 7.3 | 5.6 | 5.7 | 7.4 |
| Lipstick 2 on cotton | 4.5 | 5.8 | 5.6 | 7 |
| Makeup on cotton | n.d. | 9.5 | 9.1 | 9 |
| Lipstick 1 on polyester | 6.3 | 8.4 | 15.2 | 13.5 |
| Lipstick 2 on polyester | 9 | 9.3 | 9.2 | 8.1 |
| Shoe polish on polyester | 6.6 | 9.4 | 24.8 | 16 |

n.d.: not determined

1-2. (canceled)

3. A method for washing textiles with a detergent and a polyester accessible from dicarboxylic acid selected from terephthalic acid and mixtures of terephthalic acid and isophthalic acid, as well as ethylene glycol and polyethylene glycol with the average molar weights within a range of 2,000 g/mol to 8,000 g/mol, wherein in the polyester, the molar ratio of terephthalic acid to isophthalic acid lies within a range of 100:0 to 40:60, the molar ratio of oxyethylene groups consisting of ethylene glycol and polyethylene glycol to carboxylic acid groups of dicarboxylic acid lies within a range of 5:1 to 25:1, the molar ratio of ethylene glycol to dicarboxylic acid is less than 0.5, the molar ratio of polyethylene glycol to dicarboxylic acid is greater than 0.5, and the average molar weight of polyethylene glycol is below 1,000 g/mol.

4. The method according to claim 3, characterized in that the used concentration of the polyester in the washing liquor lies within a range from 0.0001 g/l to 10 g/l.

5. The method according to claim 3, characterized in that the method is performed using a detergent containing the polyester.

6. The method for washing textiles according to claim 3, characterized in that the method is performed using a laundry aftertreatment means.

7. A detergent or laundry aftertreatment means containing a polyester accessible from dicarboxylic acid selected from terephthalic acid and mixtures of terephthalic acid and isophthalic acid, as well as ethylene glycol and polyethylene glycol with the average molar weights within a range of 2,000 g/mol to 8,000 g/mol, wherein in the polyester, the molar ratio of terephthalic acid to isophthalic acid lies within a range of 100:0 to 40:60, the molar ratio of oxyethylene groups consisting of ethylene glycol and polyethylene glycol to carboxylic acid groups of dicarboxylic acid lies within a range of 5:1 to 25:1, the molar ratio of ethylene glycol to dicarboxylic acid is less than 0.5, the molar ratio of polyethylene glycol to dicarboxylic acid is greater than 0.5, and the average molar weight of polyethylene glycol is below 1,000 g/mol.

8. The means according to claim 7, characterized in that it contains water and is liquid.

9. The means according to claim 7, characterized in that the means contains the polyester in amounts of 0.001% by weight to 10% by weight.

10. The method according to claim 3, characterized in that the average molar weight of the polyester lies within a range of 2,500 g/mol to 5,000 g/mol, and/or the molar ratio of oxyethylene groups consisting of ethylene glycol and polyethylene glycol to carboxylic acid groups consisting of dicarboxylic acid lies within the range of 7:1 to 18:1, and/or the molar ratio of ethylene glycol to dicarboxylic acid is less than 0.35, and/or the molar ratio of polyethylene glycol to dicarboxylic acid is greater than 0.65, and/or the average molar weight of the polyethylene glycol lies within a range of 300 g/mol to 800 g/mol.

11. The means according to claim 8, characterized in that the average molar weight of the polyester lies within a range of 2,500 g/mol to 5,000 g/mol, and/or the molar ratio of oxyethylene groups consisting of ethylene glycol and polyethylene glycol to carboxylic acid groups consisting of dicarboxylic acid lies within the range of 7:1 to 18:1, and/or the molar ratio of ethylene glycol to dicarboxylic acid is less than 0.35, and/or the molar ratio of polyethylene glycol to dicarboxylic acid is greater than 0.65, and/or the average molar weight of the polyethylene glycol lies within a range of 300 g/mol to 800 g/mol.
